(19) United States
(12) Patent Application Publication
(10) Pub. No.: US 2010/0078496 A1
(43) Pub. Date: Apr. 1, 2010

(54) METHODS AND SYSTEMS FOR ULTRASONIC SPRAY SHAPING

(75) Inventor: Benjamin Massimi, New Paltz, NY (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Sono-Tek Corporation, Milton, NY (US)

(21) Appl. No.: 12/569,169

(22) Filed: Sep. 29, 2009

Related U.S. Application Data
(60) Provisional application No. 61/100,818, filed on Sep. 29, 2008.

(51) Int. Cl. B05B 17/06

(52) U.S. Cl. 239/4; 239/102.2

(57) ABSTRACT

New and improved ultrasonic spray shaping assemblies, components thereof, and methods for using the assemblies. An ultrasonic spray shaping assembly includes jet block and impact jet components to receive and redirect a single gas stream, whereby to use the single gas stream to shape an ultrasonic spray plume in a desired shape, particularly into a desired width of the plume. Modifications to the components, such as relative positioning, can be used to alter the shape of the spray plume. The present invention can be fabricated in a compact, lightweight design. It has many applications, including but not limited to, the deposition of flux onto a printed circuit board.

### CLAIM FOR PRIORITY

The present application is a non-provisional application that claims priority to U.S. Provisional Patent Application Ser. No. 61/100,818, filed Sep. 29, 2008, the disclosure of which is hereby incorporated by reference in its entirety.

### FIELD OF THE INVENTION

The present invention relates generally to the field of ultrasonic spraying and more particularly to the field of ultrasonic nozzle plume spray shaping.

### BACKGROUND OF THE INVENTION

Ultrasonic nozzles are known to produce a low velocity atomized spray plume. It is desirable to control the deposition of the micron sized atomized drops in the spray plume produced by the ultrasonic nozzle. Due to the small size and thus light weight of the atomized drops, the spray plume from an ultrasonic nozzle is easily disturbed by air currents in the coating facility. If the atomized drops in the plume are not directed to a desired location in some manner, many or all of the drops

One current method of shaping the plume produced by an ultrasonic nozzle consists of two streams of gas shearing the plume in order to produce a spray angle and direct the atomized liquid droplets to the substrate. In some embodiments one of the two gas streams, or a third gas stream, is used to redirect the entrained droplets perpendicular to the original direction of the shearing gas streams. The interaction of two and sometimes three separate gas streams often causes the pattern deposited on the substrate to exhibit non-uniformity. The use of multiple gas streams to shape the ultrasonic spray plume requires precise control of each stream to produce a uniform spray pattern.

The present inventors have identified significant deficiencies associated with the existing processes. The use of multiple, precisely controlled gas streams to shape and/or direct the ultrasonic spray plume raises issues associated with the difficulty of controlling the various gas streams and hence the spray plume. While it is possible to shear the atomized liquid off the tip of the ultrasonic nozzle using a sheet of gas as produced by an air knife to direct the atomized droplets, this will not provide an acceptable pattern width. The pattern width will be only slightly greater than the original ultrasonic spray plume.

### SUMMARY OF THE INVENTION

At least in consideration of the above discussion, it would be advantageous to overcomes the shortcomings of the prior art by using a single gas stream to entrain the atomized drops of the ultrasonic spray plume in such a way as to spread them at an angle, which will produce a spray pattern that is wider than the original ultrasonic spray plume.

The present invention is for an apparatus for shaping the plume of an ultrasonic spray. It has a body including a gas stream input and a liquid stream input; an ultrasonic nozzle connected to the body for receiving the liquid stream and converting the liquid stream to an ultrasonic spray; and an assembly connected to the body for receiving and shaping the gas stream and directing the gas stream relatively perpendicular to the ultrasonic spray to control a plume shape of the ultrasonic spray.

An additional embodiment is for a method for shaping the plume of an ultrasonic spray to deposit flux on a printed circuit board. It comprises receiving a gas stream input and a liquid flux stream input; converting the liquid flux stream to an ultrasonic flux spray; shaping the gas stream; and directing the gas stream relatively perpendicular to the ultrasonic flux spray to control a plume shape of the ultrasonic flux spray; and directing, using the assembly, the ultrasonic flux spray onto a printed circuit board, whereby to deposit the flux upon the printed circuit board.

Another embodiment, a method for shaping the plume of an ultrasonic spray to deposit material on a fuel cell, comprises receiving a gas stream input and a liquid phosphoric doping material stream input; converting the liquid phosphoric doping material stream to an ultrasonic phosphoric doping material spray; shaping the gas stream; and directing the gas stream relatively perpendicular to the ultrasonic phosphoric doping material spray to control a plume shape of the ultrasonic phosphoric doping material spray; and directing, using the assembly, the ultrasonic phosphoric doping material spray onto a fuel cell first surface, whereby to deposit the phosphoric doping material upon the fuel cell first surface.

In still another embodiment, a means for shaping the plume of an ultrasonic spray to deposit a material on a surface, comprises receiving means for a gas stream input and a liquid stream input; and means for converting the liquid stream to an ultrasonic spray; and means for shaping the gas stream; and means for directing the gas stream relatively perpendicular to the ultrasonic spray to control a plume shape of the ultrasonic spray; and means for directing, using the assembly, the ultrasonic spray onto a surface, whereby to deposit the liquid stream upon the surface.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a diagrammatic view of an assembly for controlling the shape of an ultrasonic spray plume.

FIGS. 2 and 3 are diagrammatic views of the assembly of FIG. 1 including exemplary dimensional markings.

FIGS. 4 and 5 are three dimensional top and frontal views of an embodiment of the assembly in operation.

### DETAILED DESCRIPTION

### Structure of the Spray Shaping Assembly

The invention will now be described with reference to the drawing figures, in which like reference numerals refer to like parts throughout. An impact spray shaping assembly 20 of the Figure addresses the issues mentioned above. The impact spray shaping assembly consists of four main components: an impact jet 10, a jet block 11, spray shaping gas supply fitting 12 and the ultrasonic nozzle 14. Liquid is supplied to the ultrasonic nozzle through the liquid supply fitting 13. The jet block 11 was designed to hold the ultrasonic nozzle 14 and the impact jet 10 in the required orientation in relation to each other. The jet block 11 also provides the means for air to be supplied to the impact jet 10 through the spray shaping gas supply fitting 12.

The impact jet 10 is a flat fan hydraulic nozzle, for example a K type nozzle. The jet 10 is typically used in washing applications requiring a high impact force. Typical spray angles are available from 15° to 50° for the spoon shaped deflecting face design. Impact spray shaping assemblies 20 of the present invention have been produced with jets 10 at angles form 15° to 50°, with equal amounts of success, especially with a jet at 15°, 35° and 50°.

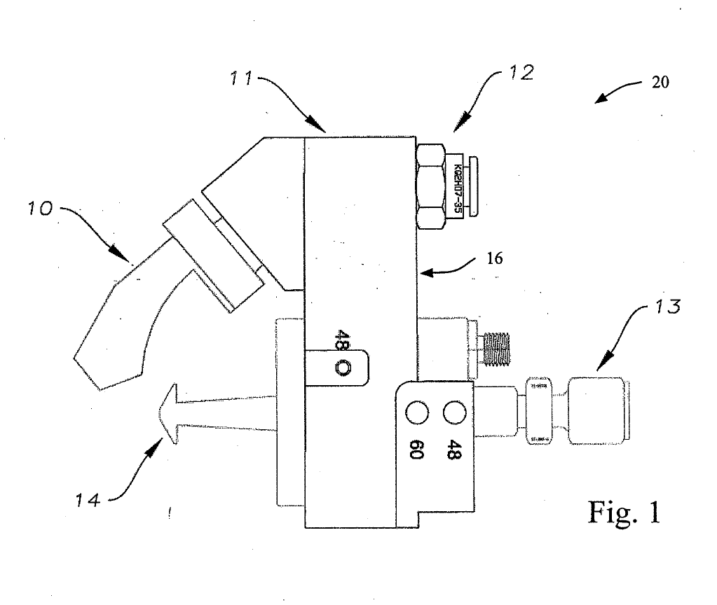

FIG. 1 shows a reciprocating fluxer operated of the present invention in which the jet is 50°. The deflection angle is related to the spray angle. For example, the 15°, 35° and 50° spray angles, the deflection angles are 5°, 35° and 55°, respectively. The deflection angle and spray angle correlation may change from manufacturer, depending on design. They are typically referred to as nozzles, although referred to herein as a jet due to the use in this application and to avoid confusion when referencing the ultrasonic nozzle 14. They are typically manufactured in brass and 303 stainless steel or any other corrosion resistant, non or low reacting material. In this present embodiment there is used a 316—stainless steel piece due to the corrosive nature of fluxes.

In an additional embodiments, the jet can be Teflon (PTFE). This material has provided the same deflection and spray angles as brass and 303 stainless steel. The impact jet 10 is available in many different sizes with different spray angles, deflection angles and orifice sizes. The impact jet 10 used is selected based upon size, weight and air flow specifications decided appropriate for the application, for example the fluxer application described below.

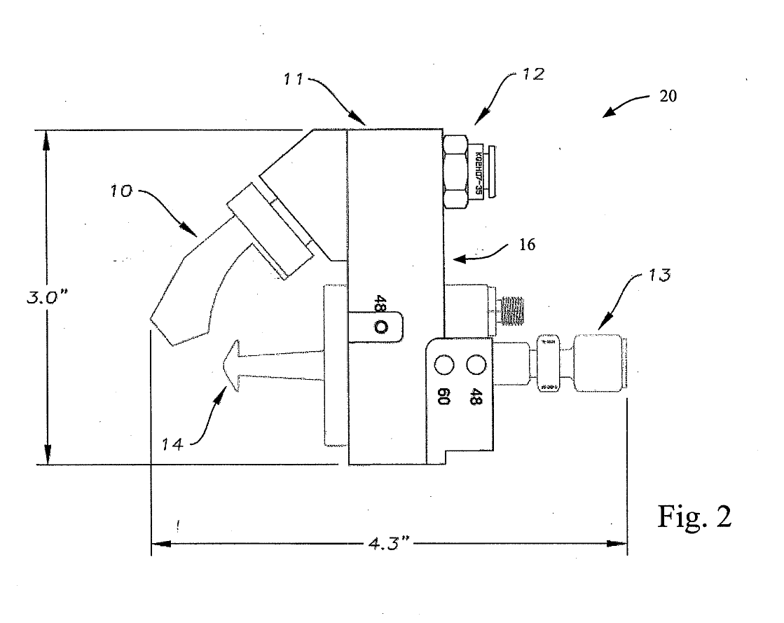

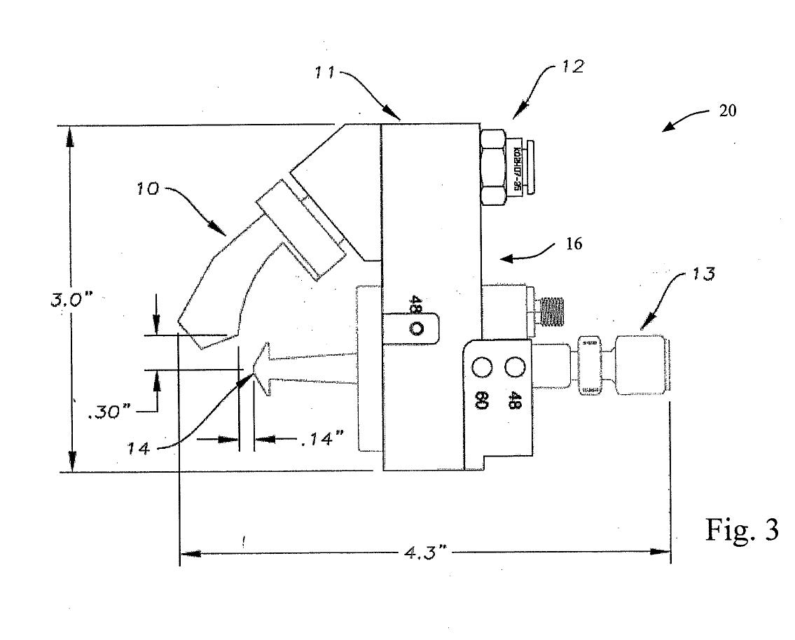

The main function of the jet block 11 is to support impact jet 10 and the ultrasonic nozzle atomizing surface 14 in the correct orientation in relation to each other. The correct orientation provides that the ultrasonic spray is sheared perpendicular to the atomizing surface and that all of the atomized liquid drops are entrained in the flat fan gas stream. The jet block 11 also can support the gas supply fitting 12 and provides a path for the gas to exit the gas supply fitting 12 and enter the impact jet 10. The current jet block 11 design provides through-holes (not shown) in order to use a screw to thread into a flat on the body of ultrasonic nozzle 14. The jet block 11 also has two locations in which brackets (not shown) can be placed to orient the ultrasonic nozzle 14 atomizing surface in relation to the exit of the gas stream from the impact jet 10. Brackets can be designed and fabricated for any number of nozzles other than the one pictured in FIG. 20. The described jet block 11 is designed around the size of the ultrasonic nozzle 14, the size of the impact jet 10 and the 55° deflection angle of the impact jet 10 shown in FIGS. 2 and 3 below. The jet block 11 is made, in the described embodiment, from Ertalyte Tex. due to the light weight and corrosion resistance nature of the material and its suitability for the fluxing application described below. Ertalyte is semi crystalline, un-reinforced, thermoplastic polyester based on polyethylterephthalate (PET-P). It's has an excellent dimensional stability together with superb wear resistance, a low co-efficient of friction, high power, & resistance to fairly acidic solutions. Ertalyte's properties make it particularly suitable for the construction of precision perfunctory parts which are capable of supporting high loads & enduring wear circumstances. Ertalyte PETP can be machined to accurate detail on normal metal working gear.

Therefore, the jet block 11 can be produced from any number of materials including aluminum, stainless steel, Delrin, Teflon, etc. The selected material desirably retains dimensional stability and provides suitable corrosion resistance for the desired application.

With reference now to FIGS. 2 and 3, jet block 11 is designed, that is shaped, dimensioned and positioned, to support the impact jet 10 and the ultrasonic nozzle 14 atomizing surface in a particular relation to each other. The design reference in FIGS. 2 and 3 is based on an ultrasonic nozzle, which can atomize flow rates from approximately 10 ml/min to 70 ml/min. The ultrasonic atomizing surface diameter, i.e. the tip of nozzle 14, can range from 0.23 inches to 0.75 inches. For example, 0.46 inches is used in a described embodiment. The edge of the deflection surface on the impact jet 10 can be located from 0.03 inches to 0.75 inches. For example, 0.14 inches is used in a described embodiment and is measured horizontally from the center of the atomizing surface and 0.06 inches to 0.63 inches. For example, 0.30 inches is used in a described embodiment and is measured vertically from the atomizing surface. The provided dimensions are based on the 50° impact jet 10 in system 20. The dimensions can be altered based on other impact jet designs available. The gas supplied to the impact jet 10 is between 5 and 15 psi. The plume diameter when sheared by the impact gas stream is approximately equal to or less than the atomizing surface diameter. The plume diameter depends on the flow rate and power being supplied to the ultrasonic nozzle. The pattern width produced on the substrate can range from one inch to six inches, depending on liquid flow rate, gas pressure and height of the assembly from the substrate. For example, in one embodiment using components and materials as described above, the flow rate is equal to 48 ml/min, the gas pressure is equal to 10 psi, the height is equal to 6 inches from substrate, resulting pattern width is equal to 3 inches.

Ultrasonic nozzle 14 comprises any appropriate ultrasonic nozzle, for example an appropriate 8700-series model of the type manufactured and sold by the Sono-Tek Corporation. The gas supply fitting 12 and liquid supply fitting 13 comprise conventional components well known to the reader.

### Operation of the Spray Shaping Assembly

The assembly uses a single gas stream, which is converted into a flat fan pattern, to entrain the drops in the ultrasonic spray plume. The gas stream is created by the flow of pressurized gas introduced into the assembly through the spray shaping gas supply fitting 12. The gas is forced through the jet block 11 and introduced to the impact jet 10. The flat fan spray angle is produced by the impact of the gas stream on the deflecting surface of the impact jet 10. The deflecting surface produces not only the spray angle and converts the gas stream to a flat fan pattern, but the orientation shears the ultrasonic spray plume perpendicular to the ultrasonic nozzle atomizing surface 14. Through-holes on the jet block 11 and threaded holes on the body of the ultrasonic nozzle 14 insure that the atomizing surface of the ultrasonic nozzle 14 is oriented correctly in relation to the Impact jet 10. The ultrasonic spray plume is entrained in the spray angle of the flat fan pattern produced by the impact jet 10. Due to the entrainment of the ultrasonic spray plume in the flat fan, the pattern width deposited on the substrate can be many times the diameter of the ultrasonic spray plume. The pattern width deposited on the substrate can be affected by several variables. They include: impact jet 10 spray angle, plume size due to liquid flow rate, gas flow rate and pressure of gas stream impacting the deflecting surface and orientation of the impact jet 10 in relation to the ultrasonic nozzle atomizing surface 14.

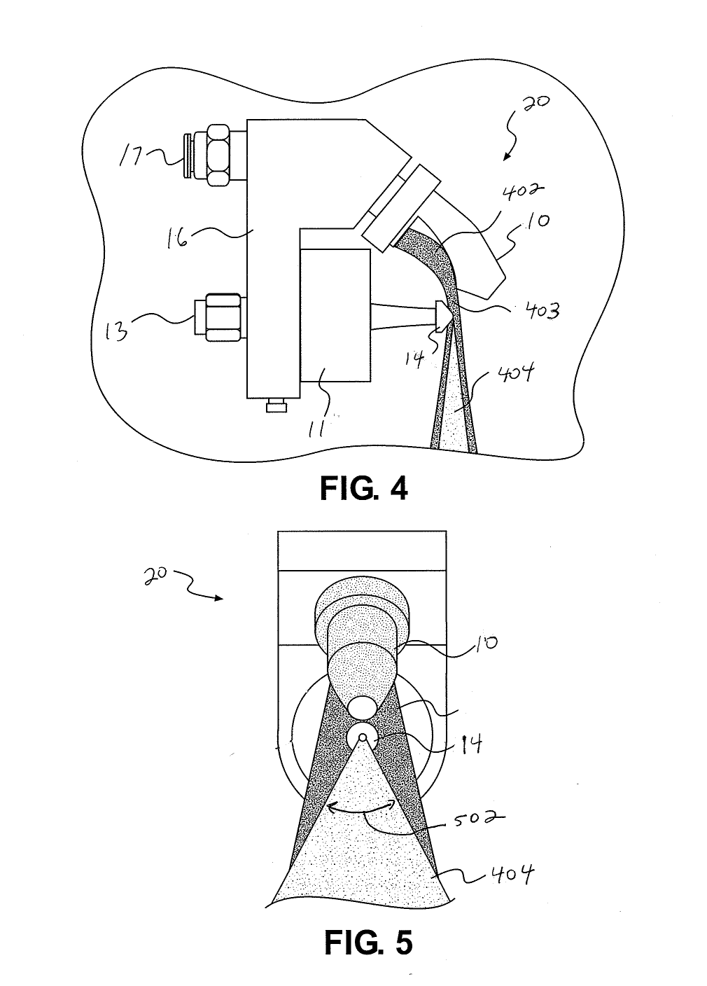

With reference now to FIGS. 4 and 5, FIG. 4 shows a top view of the described assembly 20 in operation, with the gas stream 402 directed, by the described assembly, producing a shaped gas stream 403 across the path of the ultrasonic liquid plume 404. FIG. 5 shows the resultant, desired, shaping 502 of the ultrasonic plume 404.

The Impact Spray Shaping Assembly of the present invention produces a pattern width many times the width of the ultrasonic spray plume. The orientation of the Impact Jet 10 and the atomizing surface of the ultrasonic nozzle 14 in relation to each other are unique, as described. Changes in the orientation of the components can be used to alter the pattern width, as described. The Impact Spray Shaping Assembly can be assembled with light weight, compact components in order to be used in reciprocating spray fluxing machines.

### Exemplary Uses of the Spray Shaping Assembly

One intended use of the Impact Spray Shaping Assembly is in the printed circuit board (PCB) fluxing industry. Prior to components being soldered to a PCB the board must be coated with flux. This is often done by spraying the flux onto the PCB. The PCB is placed on a conveyor and the spray nozzle reciprocates perpendicular to the motion of the PCB. Air atomizing nozzles, nozzles which use high velocity air to break apart (atomize) the liquid, have, here to for, often been used in this application. The Impact Spray Shaping Assembly of the present invention provides significant improvements over air atomizing nozzles in this and other applications. The orifice sizes in air atomizing nozzles are small, relative to ultrasonic nozzles, due to the high velocity required to atomize liquid. The small orifices easily clog. This leads to non-uniform coverage or no coverage if the orifices clog fully. The liquid feed orifice in the ultrasonic nozzle is large, relative to the orifice in an air atomizing nozzle. This alone leads to reduced clogging during operation, but the ultrasonic vibration in the nozzle virtually eliminates the possibility of clogging in the ultrasonic nozzle. The orifice in the Impact jet which supplies the gas stream for spray shaping is also large relative to the spray shaping orifices associated with an air atomizing nozzle. The orifice in the Impact jet can be large due to the difference in air velocity required to entrain ultrasonic atomized drops versus the air velocity required to entrain air atomized drops.

In an additional embodiment, the present invention can be used in solar cell manufacturing. The spraying apparatus and techniques taught by the present invention can by used to solder bus flux silicon solar cells or depositing suspensions for transparent conductive oxide (TCO) layers in thin film solar cell manufacturing.

The present invention can do phosphoric doping and spray pyrolysis applications for production of fuel cells by applying the material to a fuel cells first surface. The present invention can be used to coat Proton Exchange Membranes with catalyst inks such as carbon black and other precious metal suspensions onto nafion membranes.

In another embodiment, the present invention can be utilized to coat baked goods. For example, the present invention could coat the top of a bread or Danish with a ultrafine coating of egg wash to produce a shinny glazed look on the top of the bread or Danish. The present invention could also coat the bread with a micro fine coating of preservative to help keep the bread fresh and keep the bread form growing mold.

### Other Features and Advantages of the Present Invention

The atomized drops produced by the ultrasonic nozzle are ejected from the atomizing surface at very-low velocity. The atomized drops produced by an air atomizing nozzle are ejected from the nozzle at very high velocity. Due to the low velocity of the ultrasonic atomized drops they can be entrained by a low velocity gas stream. The high velocity drops produced by an air atomizing nozzle must be entrained by high velocity gas streams in order to change the direction of the drops and produce the desired spray pattern. In the prior art, the high velocity of the atomized drops and the spray shaping gas streams associated with air atomizing nozzles led to clogged orifices and exhaust systems, low transfer efficiency, wasted process chemicals and extended cleaning time of the spray fluxing machines. Air atomizing nozzles typically used two gas streams to create the flat fan spray pattern used in fluxing machines. The interaction of two high velocity gas streams to create the spray pattern led to non-uniformity in the spray pattern if there is a slight difference in pressure, flow or direction of one of the gas streams. The Impact Spray Shaping Assembly of the present invention uses only a single gas stream for spray shaping and thus avoids this issue. This leads to a more consistent pattern over extended production runs. The pattern produced by the Impact Spray Shaping Assembly is unique in the fact that it is not produced by two blended gas streams meeting at a centralized location. The Impact Spray Shaping Assembly pattern is produced by a single gas stream and thus does not require two or more individual streams of entrained atomized drops to meet and produce a uniform pattern.

Other ultrasonic devices, not nozzles, have been used in the spray fluxing of PCBs. These prior art devices use side liquid feed apparatus, which is prone to clogging. They also use multiple gas streams to entrain the atomized drops to produce the desired spray pattern. These ultrasonic devices produce a spray pattern equal or only slightly greater than the pattern width of the atomized liquid. The Impact Spray Shaping Assembly of the present invention has the ability to produce a pattern width many times the width of the ultrasonic plume. The Impact Spray Shaping Assembly is unique in the fact that it has a single gas delivery and a single liquid delivery. Other ultrasonic and air atomizing devices require multiple liquid and gas delivery in order to produce and atomized spray suitable to coat PCBs with flux. The Impact Spray Shaping Assembly of the present invention is unique in its ability to spray in any orientation. This allows the Impact Spray Shaping Assembly to be orientated perpendicular to the conveyor carrying the PCB through the fluxing chamber to the wave solder machine. Other, prior art ultrasonic devices with liquid side feed apparatus must be located on a horizontal plane or the liquid being delivered through the side feed apparatus is not distributed uniformly on the atomizing surface. This causes the spray pattern to be non-uniform and produces an unacceptable coating. Due to the use of an ultrasonic nozzle with a central liquid feed orifice to the atomizing surface the ultrasonic spray plume is not affected by the orientation of the Impact Spray Shaping Assembly of the present invention.

There have thus been provided new and improved ultrasonic spray shaping assemblies, components thereof, and methods for using the assemblies. In accordance with the present invention, the ultrasonic spray shaping assembly includes jet block and impact jet components to receive and redirect a single gas stream, whereby to use the single gas stream to shape an ultrasonic spray plume in a desired shape, particularly into a desired width of the plume. Modifications to the components, such as relative positioning, can be used to easily alter the shape of the spray plume. The present invention can be fabricated in a compact, light-weight design. It has many applications, including but not limited to, the deposition of flux onto a printed circuit board.

While the invention has been shown and described with respect to particular embodiments, it is not thus limited. Numerous modifications, changes and enhancements, within the scope of the invention, will now occur to the reader.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An apparatus for shaping the plume of an ultrasonic spray, comprising:
a body including a gas stream input and a liquid stream input;
an ultrasonic nozzle connected to the body for receiving the liquid stream and converting the liquid stream to an ultrasonic spray; and
an assembly connected to the body for receiving and shaping the gas stream and directing the gas stream relatively perpendicular to the ultrasonic spray to control a plume shape of the ultrasonic spray.

2. The apparatus of claim 1 wherein the assembly includes a hydraulic nozzle for receiving, shaping and redirecting the gas stream to impact the ultrasonic spray and control the plume shape of the ultrasonic spray.

3. The apparatus of claim 2 wherein the hydraulic nozzle comprises a flat fan hydraulic nozzle.

4. The apparatus of claim 3 and further including a block for positioning the hydraulic nozzle relative to the ultrasonic nozzle.

5. The apparatus of claim 1 further including a product comprising flux deposited upon a printed circuit board.

6. The apparatus of claim 1 further including a product comprising a suspension of transparent conductive oxide (TCO) to be sprayed on in layers on a thin film solar cell.

7. The apparatus of claim 1 further including a product comprising solder bus flux for the production of silicon solar cells.

8. The apparatus of claim 1 further including a product comprising phosphoric doping material to be used in a pyrolysis production of fuel cells

9. The apparatus of claim 1 further including a product to coat Proton Exchange Membranes with a catalyst ink onto nafion membranes.

10. The apparatus of claim 9 in which the catalyst is ink is carbon black.

11. The apparatus of claim 1 further including a product to coat a bread with a preservative.

12. The apparatus of claim 1 further including a product to coat a bread with an egg wash.

13. A method for shaping the plume of an ultrasonic spray to deposit flux on a printed circuit board, comprising:
receiving a gas stream input and a liquid flux stream input; converting the liquid flux stream to an ultrasonic flux spray; shaping the gas stream;
directing the gas stream relatively perpendicular to the ultrasonic flux spray to control a plume shape of the ultrasonic flux spray; and
directing, using the assembly, the ultrasonic flux spray onto a printed circuit board, whereby to deposit the flux upon the printed circuit board.

14. A method for shaping the plume of an ultrasonic spray to deposit material on a fuel cell, comprising:
receiving a gas stream input and a liquid phosphoric doping material stream input; converting the liquid phosphoric doping material stream to an ultrasonic phosphoric doping material spray; shaping the gas stream;
directing the gas stream relatively perpendicular to the ultrasonic phosphoric doping material spray to control a plume shape of the ultrasonic phosphoric doping material spray; and
directing, using the assembly, the ultrasonic phosphoric doping material spray onto a fuel cell first surface, whereby to deposit the phosphoric doping material upon the fuel cell first surface.

15. The method of claim 14 in which the stream material is a catalyst inks and the fuel cell's first surface is a Proton Exchange Membrane.

16. The method of claim 13 in which the stream material is a transparent conductive oxide and the printed circuit board is a thin film solar cell.

17. A means for shaping the plume of an ultrasonic spray to deposit a material on a surface, comprises
receiving means for a gas stream input and a liquid stream input;
means for converting the liquid stream to an ultrasonic spray;
means for shaping the gas stream;
means for directing the gas stream relatively perpendicular to the ultrasonic spray to control a plume shape of the ultrasonic spray; and
means for directing, using the assembly, the ultrasonic spray onto a surface, whereby to deposit the liquid stream upon the surface.

18. The apparatus of claim 2 in which the flat fan is made form brass, stainless steel or Teflon.

19. The apparatus of claim 3 in which the block is stainless steel, Teflon or ertalyte.
